(19) United States
(12) Patent Application Publication
(10) Pub. No.: US 2018/0326835 A1
(43) Pub. Date: Nov. 15, 2018

(54) DRIVE MODAL

(71) Applicant: Connected Mobil Group, LLC, Naperville, IL (US)

(72) Inventors: Paul Wolfe, Lexington, SC (US); Prasad Keshava, Naperville, IL (US)

(73) Assignee: Connected Mobil Group, LLC, Naperville, IL (US)

(21) Appl. No.: 15/974,747

(22) Filed: May 9, 2018

Related U.S. Application Data
(60) Provisional application No. 62/503,980, filed on May 10, 2017.

(51) Int. Cl. B60K 7/00; B60K 1/02

(52) U.S. Cl. CPC B60K 7/0007; B62D 3/126; B60K 2007/0061; B60K 1/02

(57) ABSTRACT

An insertable drive modal for replacing an existing electric motor and drive configuration in an electric vehicle or for converting an internal combustion vehicle to an electric vehicle with a new motor and drive configuration.

### BACKGROUND OF THE INVENTION

### 1) Field of the Invention

The present invention relates to an insertable drive modal for replacing an existing electric motor and drive configuration in an electric vehicle or for converting an internal combustion vehicle to an electric vehicle with a new electric motor and drive configuration.

### 2) Description of Related Art

Currently, electric vehicle motor systems use electric motors to simply replace internal combustion engines in a conventional drivetrain configuration, see FIGS. 1A and 1B, which illustrate prior art drivetrain configurations. FIG. 2 shows an actual construction of a prior art conventional electric drive system that only replaces the internal combustion engine with an electric motor. This system still includes the gearbox and affixes the electric motor thereto. However, this system is unnecessarily complex and involves a plethora of parts that may wear out or malfunction.

Accordingly, it is an object of the present invention to provide a simplified drive modal for electric vehicles that reduces the complexity of the steering and propulsion system.

### SUMMARY OF THE INVENTION

The above objectives are accomplished according to the present invention by providing an insertable drive modal. The drive modal includes a first electric motor engaged with a first tire, at least one second electric motor engaged with a second tire. The first electric motor effects movement of the first tire without a gear differential and the second electric motor effects movement of the second tire without a gear differential. The first electric motor effects movement of the first tire without a transmission disposed between the first electric motor and the first tire and the at least one second electric motor effects movement of the second tire without a transmission disposed between the at least one second electric motor and the second tire. Further, the first electric motor and the second electric motor turn the first tire and the second tire in torque mode to simulate a positive traction integrated steering rack. Still further, the modal has a rack and pinion steering system. Even further, independent suspension is provided for each wheel. Still yet further, the first and at least one second electric motor engage with the same frame, brakes, and steering configuration of an existing vehicle. Further, equal torque is provided to each tire. Additionally, a smart communications link is established between the first electric motor and the at least one second electric motor. Further yet, a second drive modal is used in association with the first drive modal to control at least a third tire and at least a fourth tire. Further still, the second drive modal lacks motors, sprockets and half shafts. Even further, the first drive modal has a rack and pinion steering mechanism and the second drive modal has a tie link toe adjustment.

In another embodiment, a method for converting an internal combustion vehicle to an electric vehicle is provided. The method includes inserting a drive modal into an existing chassis of an existing vehicle. The drive modal includes a first electric motor engaged with a first tire, at least one second electric motor engaged with a second tire, the first electric motor effects movement of the first tire without a gear differential and the second electric motor effects movement of the second tire without a gear differential, and the first electric motor effects movement of the first tire without a transmission disposed between the first electric motor and the first tire and the at least one second electric motor effects movement of the second tire without a transmission disposed between the at least one second electric motor and the second tire. Further, the drive modal is inserted into the existing chassis at a front of the vehicle to provide four by two front wheel drive. Still further, the drive modal is inserted into the existing chassis at a rear of a vehicle to provide four by two rear wheel drive. Even further, a second drive modal is inserted into the vehicle to provide four by four wheel drive. Still even further, the first and at least one second electric motor engage with the same frame, brakes, and steering configuration of an existing vehicle. Even further yet, independent suspension is provided for each wheel. Still yet further, the first and at least one second electric motor engage with the same frame, brakes, and steering configuration of an existing vehicle. Further yet, equal torque is provided to each tire. Yet further still, the second drive modal is a non-steering unit and a rack of the existing vehicle may be replaced with toe links.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1A illustrates a prior art drivetrain configuration.

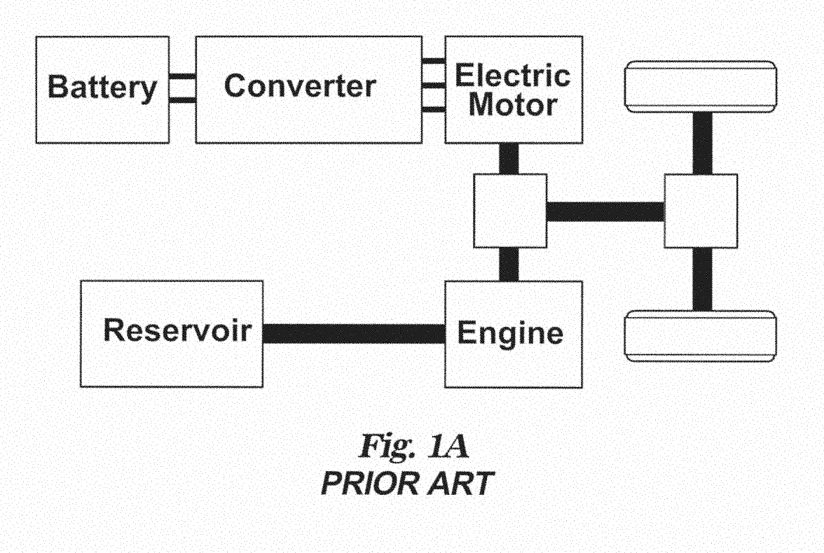

FIG. 1B shows an alternative prior art drivetrain configuration.

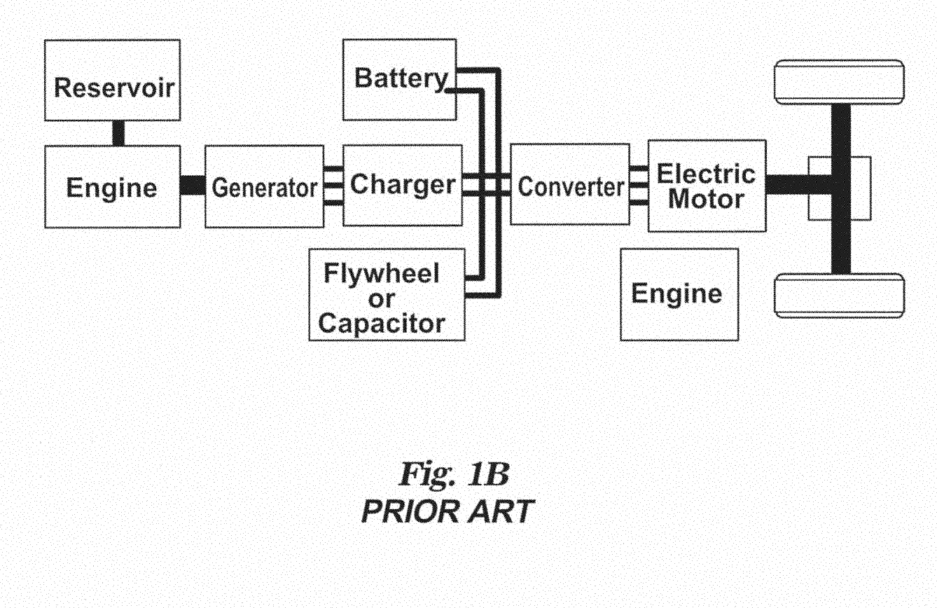

FIG. 2 shows a prior art conventional electric drive system that replaces the internal combustion engine with an electric motor.

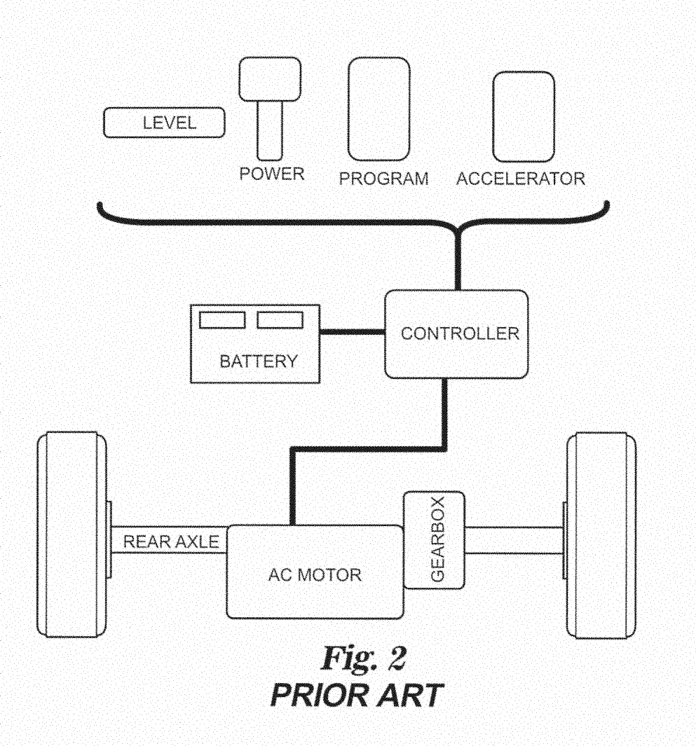

FIG. 3 shows one embodiment of a drive modal of the current disclosure.

FIG. 4A shows a drive system for one embodiment of a drive modal of the current disclosure.

FIG. 4B shows a side view of the drive system of FIG. 4A.

FIG. 4C shows one embodiment of a drive system of the current disclosure with a rack and pinion steering system.

FIG. 5 shows a smart communications link that may be established between a drive modal and a dash display.

FIG. 6 shows a non-steering drive modal wherein the rack is replaced with toe links.

FIG. 7 shows a locking clutch added to engage sprockets in order to provide an “axle lock” so that the wheels are driven together during four by four use.

FIG. 8 shows a further embodiment of a drive modal which includes a welding surface for the affixing drive modal within a vehicle, not shown.

FIG. 9 shows an alternative view of FIG. 8.

FIG. 10 shows a block diagram of a method for converting an internal combustion vehicle to an electric vehicle using a drive modal of the current disclosure.

FIG. 11 illustrates one embodiment of a Controller Area Network (CAN) that may be employed in the current disclosure.

FIG. 12 illustrates one potential embodiment of this system.

FIG. 13 illustrates one embodiment of full vehicle system integration

FIG. 14 illustrates a very simple CAN bus control that may be used with the current disclosure.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

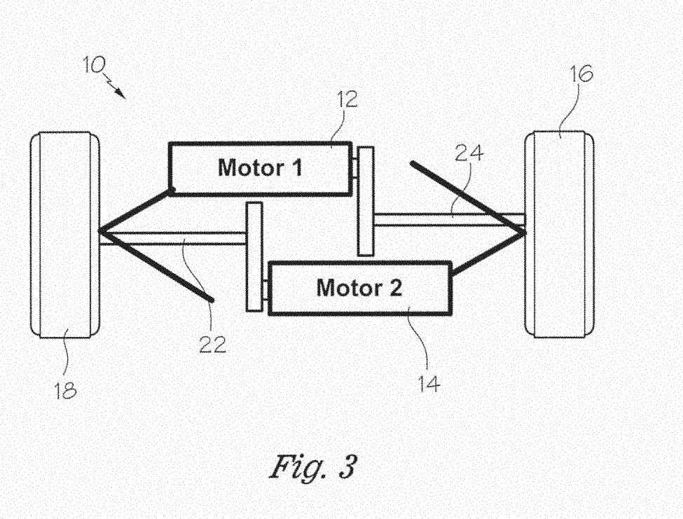

FIG. 3 shows one embodiment of a drive modal 10 of the current disclosure. Drive modal 10 includes a first motor 12 and a second motor 14. First motor 12 is engaged with first tire 16 via first axle 20 and second motor 14 is engaged with second tire 18 via second axle 22. Tires 16 and 18, in one embodiment, may be 16 inch wheels such as 225/70R16 tires. First motor 12 and second motor 14 turn their respective wheels in torque mode to simulate a positive traction integrated steering rack. Drive modal 10 may be inserted into an existing chassis of a vehicle, not shown, at the front of the chassis to provide four by two front wheel drive. Drive modal 10 may be inserted into a chassis at the rear of the vehicle for providing four by two rear wheel drive and two drive modals 10 may be inserted at both the front and back of the chassis to provide four by four wheel drive.

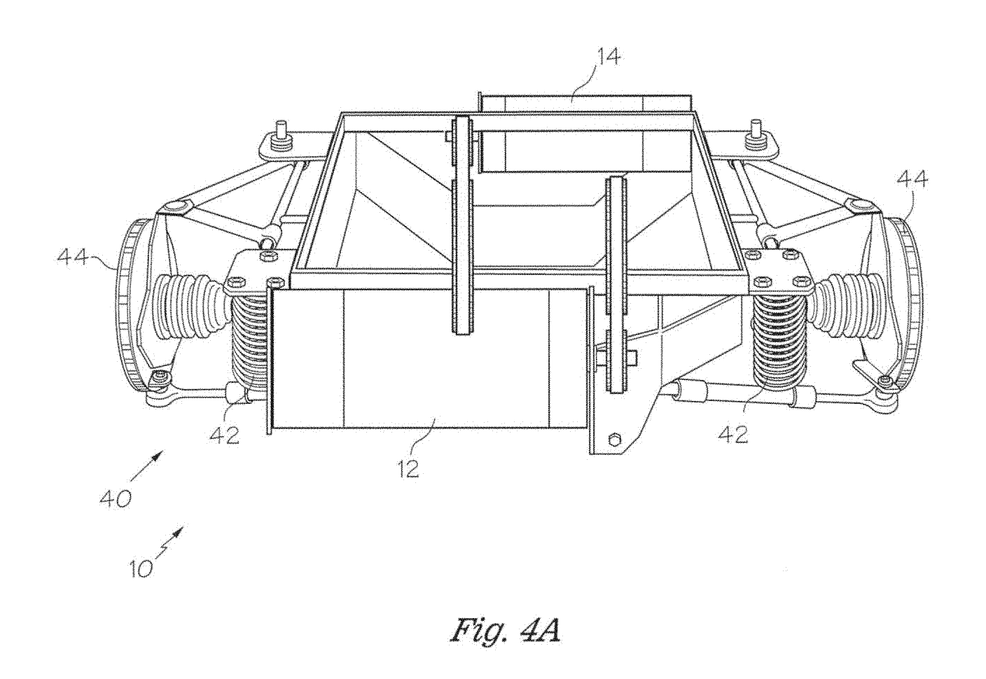

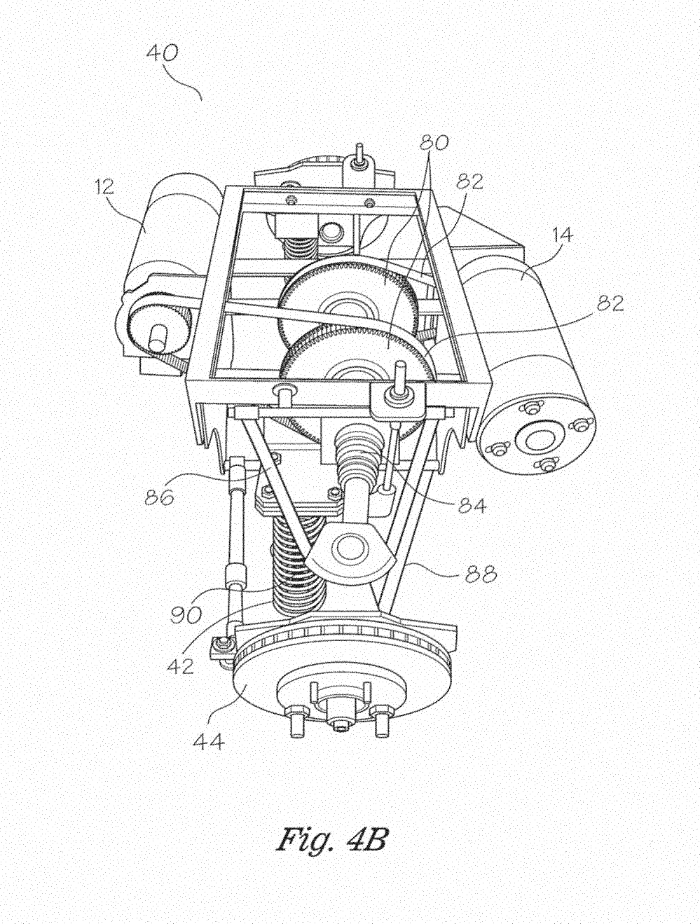

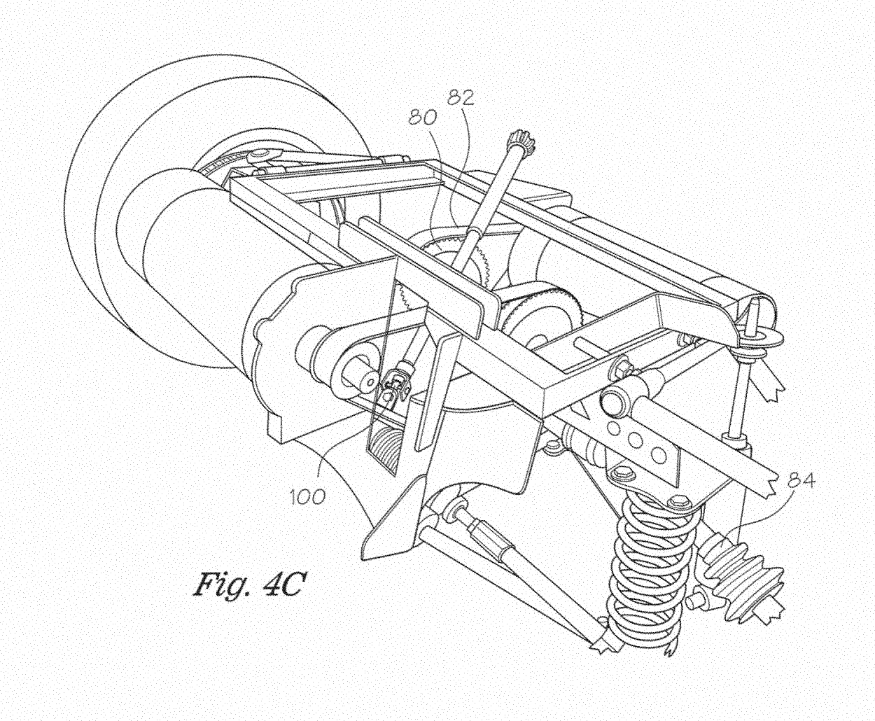

FIG. 4A shows a working drive system 40 of one embodiment of a drive modal 10 of the current disclosure. Drive system 40 may include coil springs 42 for providing suspension, as well as disk brakes 44 for slowing the wheels, not shown, of construct 40 during use. In one embodiment, disk brake 44 may comprise an 11.25 inch rotor. Drive system 40 may also include first motor 12 and second motor 14 for providing power to the wheels. Motors 12 and 14 may be AC or DC with varying horsepower. For instance, the motors may have horsepower ratings from 8 to 30, but the current disclosure should not be considered limited to this range as other horsepower values are considered herein disclosed, such as below 8 hp or above 30 hp. Drive system 40 may also include rack 46 for supporting first motor 12 and second motor 14, coil springs 42 and disk brakes 44.

FIG. 4B shows a side view of the drive system 40 of FIG. 4A. Drive system 40 may include sprockets 80, which engage drive belts 82. In one instance, drive system 40 may have a minimum gear ratio of 4.3 to 1. Drive system 40 may also include half shaft drive axles 84, as well as upper ‘A’ arms 86 and lower ‘A’ arms 88, and hydraulic damper 90. FIG. 4C shows that drive system 40 may possess rack and pinion steering system 100. Drive modal 40 provides independent suspension for each wheel.

The drive modal of the current disclosure removes the drive axle, differentials and transmission from existing vehicles by replacing these with the drive modal of the current disclosure. The drive modal may be inserted into a vehicle after market and may even employ the same frame, same brakes, same arms, same coil springs, same hydraulic dampers, same wheel bearings, and same steering parts as the original vehicle. Further, the current disclosure provides equal torque to the drive wheels, as well as fully independent suspension with relation to the four wheels.

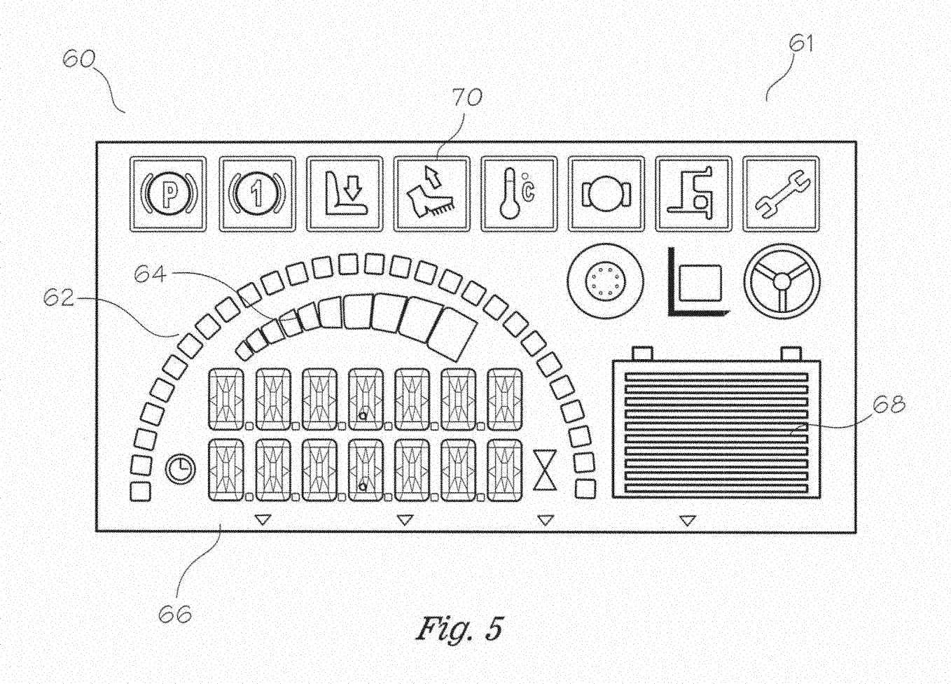

In a further embodiment, a smart communications link may be established between motors 12 and 14, controllers and a dash display 60, see FIG. 5. Smart communications link 61 may be embodied, in one embodiment, by dash display 60, which may include a speedometer 62, RPM indicator 64, mileage indicator 66, battery charge indicator 68, as well as performance indicators 70 which provide information to the user regarding the motor and/or vehicles condition and performance, regarding information such as maintenance needs, temperature, drive/park indicators, tire wear, etc.

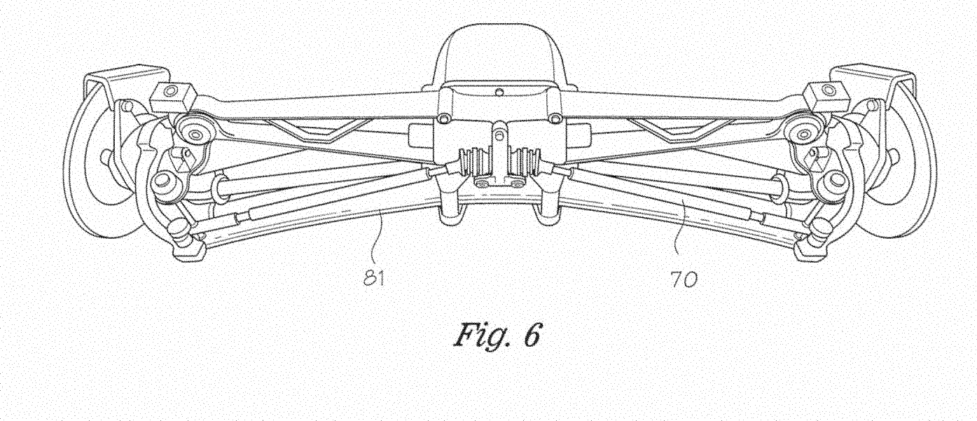

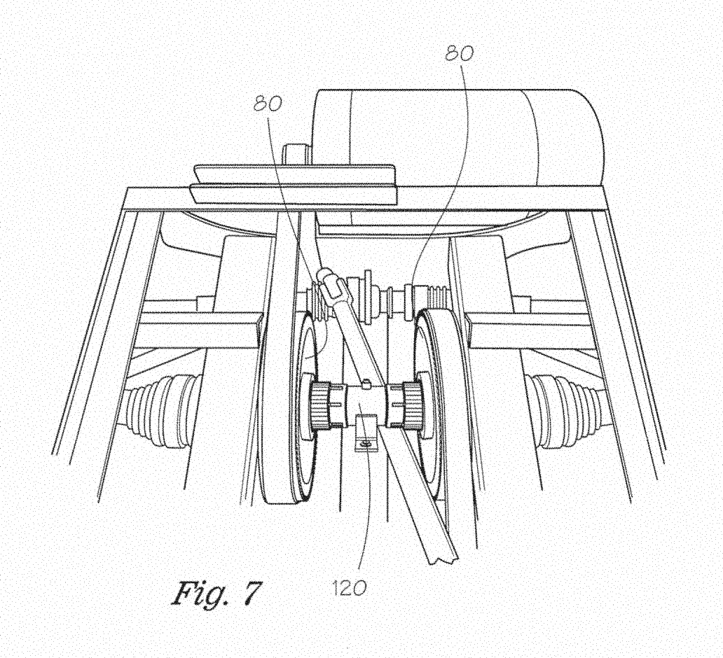

FIG. 6 shows that for non-steering units, rack 46 may be replaced with toe links 81, thus further simplifying the structure of a nonsteering drive modal 82. FIG. 7 shows that in a further embodiment, a locking clutch 120 may be added to engage sprockets 80 in order to provide an “axle lock” for the vehicle so that the wheels are driven together during four by four use. Thus, the same drive modal 40 could be placed in the front and rear of a vehicle for a four by two system with one of either the front or rear drive modals lacking motors, sprockets and half shafts. In a further embodiment a four by four wheel drive vehicle may be created by using two drive modals, each having a motor for each wheel. The “front” drive modal would have a rack and pinion steering mechanism with the “rear” drive modal having a tie link toe adjustment. This embodiment would have two drive axles on the front drive modal and two drive axles on the rear modal.

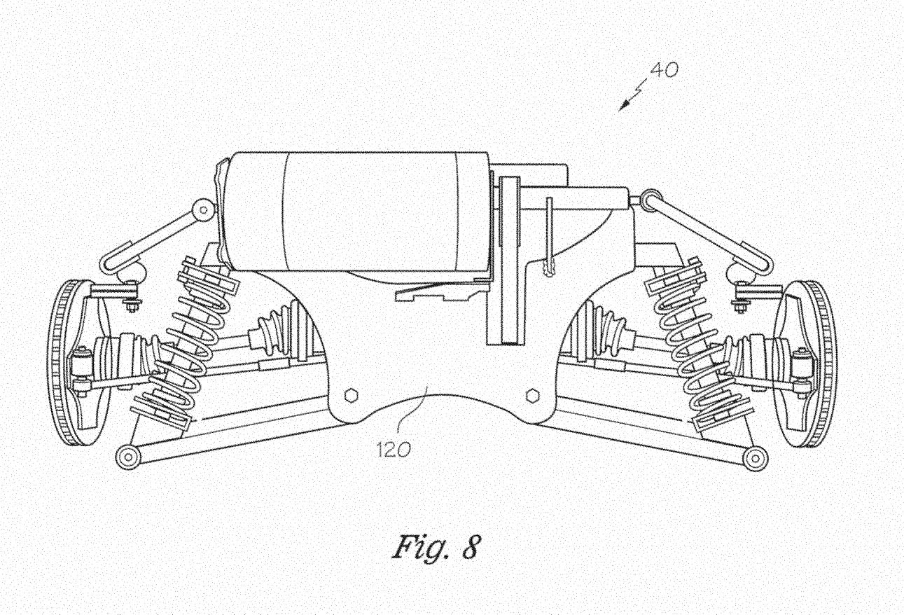

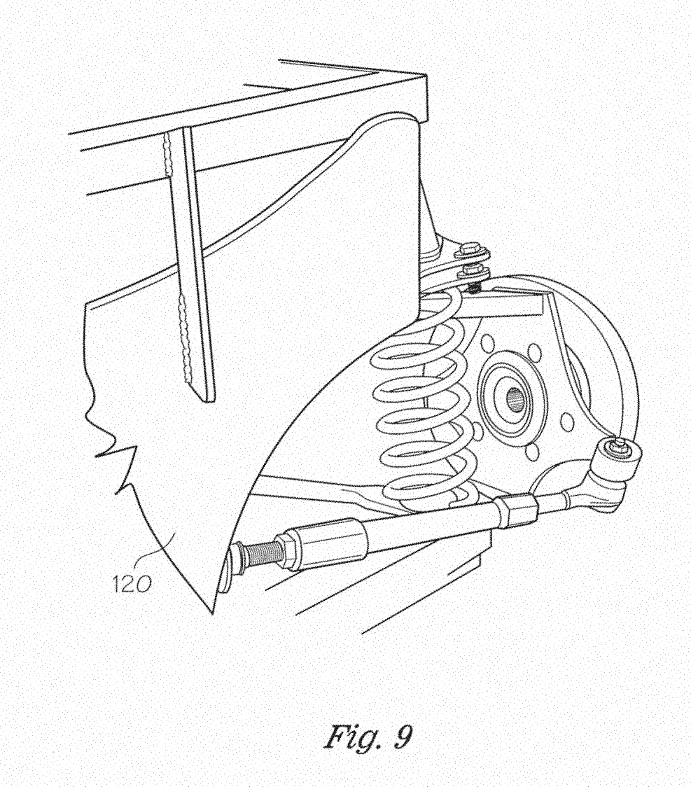

FIG. 8 shows a further embodiment of drive modal 40 which includes a welding surface 120 for affixing drive modal 40 within a vehicle, not shown. This enables a user to simply “core out” a vehicle after market and replace the existing motor, or add new electric motors, to a vehicle aftermarket. FIG. 9 shows an alternative view of FIG. 8.

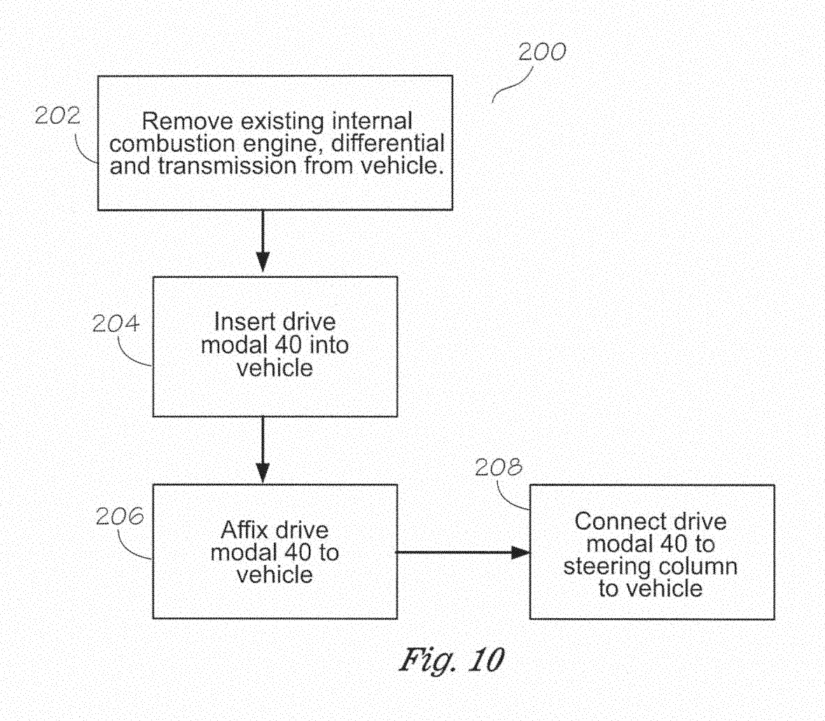

FIG. 10 shows a block diagram of a method for converting an internal combustion vehicle to an electric vehicle 200 using a drive modal 40 of the current disclosure. At step 202 one removes the existing internal combustion engine, differential and transmission from the vehicle. At step 204, drive modal 40 is inserted into the space in the vehicle previously occupied by the engine, differential, and transmission. At step 206, drive modal 40 is affixed to the vehicle. This may be via securing the frame of drive modal 40 via bolts, welding, etc., as known to those of skill in the art. At step 208, one connective drive modal 40 to the steering column of the vehicle.

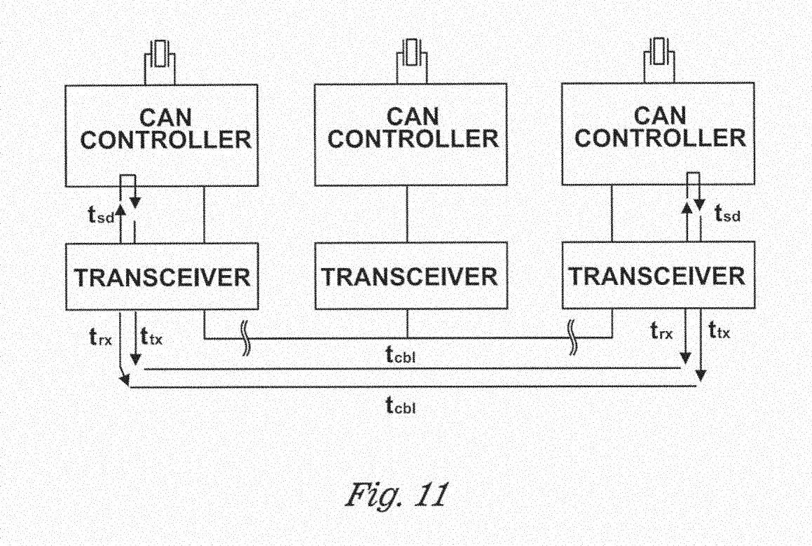

FIG. 11 illustrates one embodiment of a Controller Area Network (CAN) that may be employed in the current disclosure. As FIG. 11 shows, the CAN bus may be a broadcast type of bus. This means that all nodes can “hear” all transmissions. There is no way to send a message to just a specific node; all nodes will invariably pick up all traffic. The CAN hardware, however, provides local filtering so that each node may react only on the interesting messages. In a further embodiment, the bus uses Non-Return To Zero (NRZ) with bit-stuffing. The modules are connected to the bus in a wired-and fashion: if just one node is driving the bus to a logical 0, then the whole bus is in that state regardless of the number of nodes transmitting a logical 1. The CAN standard defines four different message types. The messages uses a clever scheme of bit-wise arbitration to control access to the bus, and each message is tagged with a priority. The CAN standard also defines an elaborate scheme for error handling and confinement. CAN may be implemented using different physical layers as well as varied numbers of connector types.

There are four different message types (or “frames”) on a CAN bus: the Data Frame, the Remote Frame, the Error Frame, and the Overload Frame.

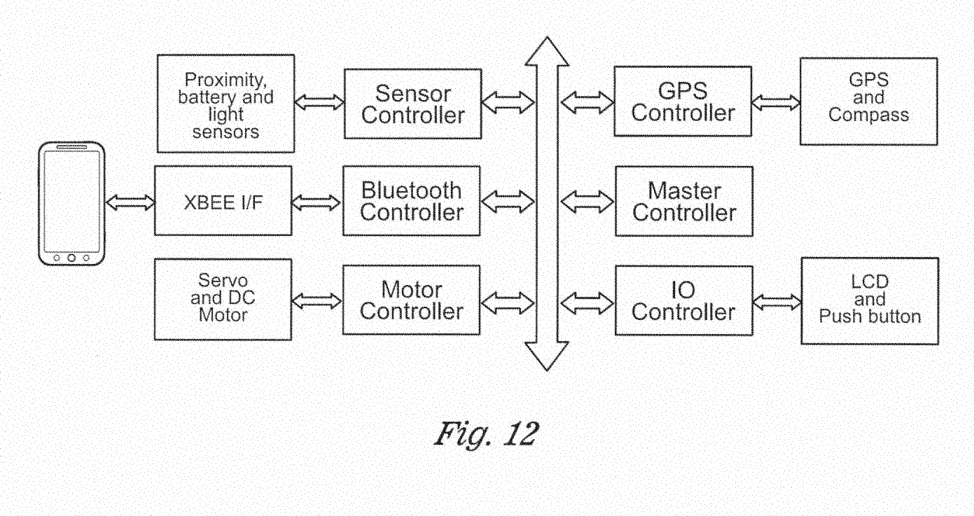

CAN buss allows the vehicles to communication through a simple (low cost) system. The system will support internet updates, download battery stasis, user data, runtime data, and software updates. Also the system will new equipment added to the system very quickly and simply. FIG. 12 illustrates one potential embodiment of this system.

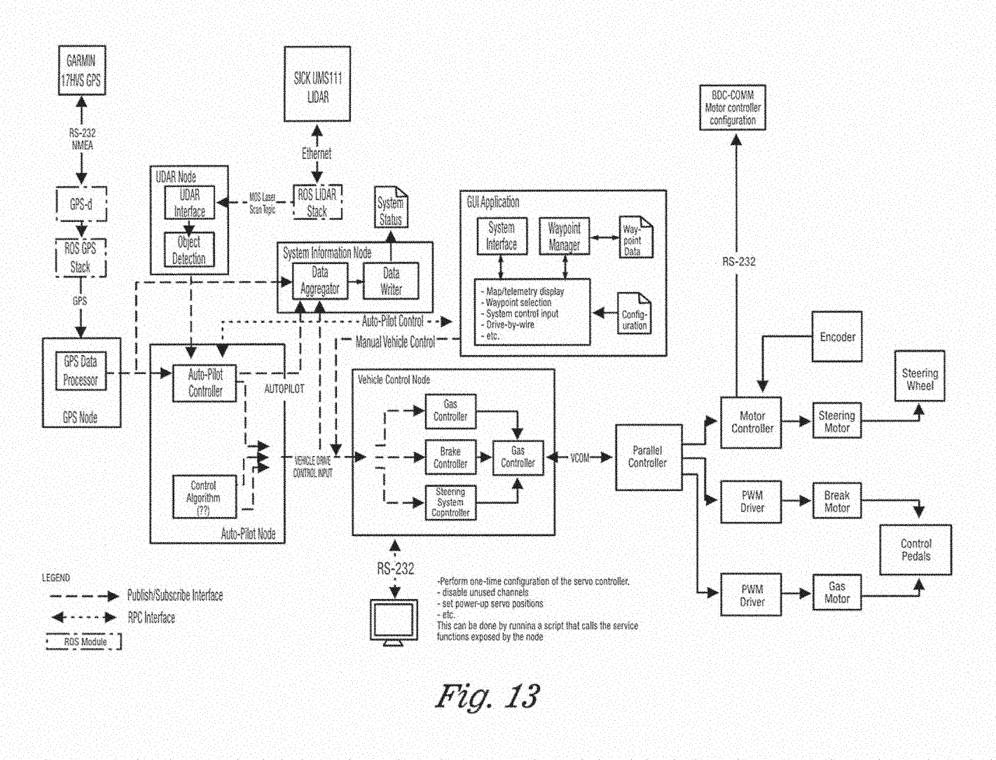

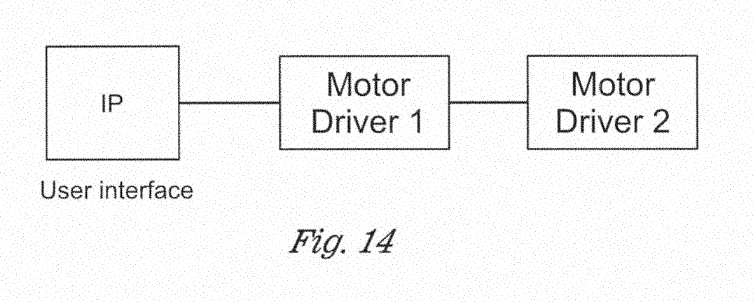

FIG. 13 illustrates that full vehicle system integration is possible. The drive module may have the full integrated system, as shown in FIG. 12, or a very simple (and low cost) CAN bus control system, as illustrated in FIG. 14.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. An insertable drive modal for a vehicle comprising:
a first electric motor engaged with a first tire;
at least one second electric motor engaged with at a second tire;
wherein the first electric motor effects movement of the first tire without a gear differential and the second electric motor effects movement of the second tire without a gear differential;
wherein the first electric motor effects movement of the first tire without a transmission disposed between the first electric motor and the first tire and the at least one second electric motor effects movement of the second tire without a transmission disposed between the at least one second electric motor and the second tire.

2. The insertable drive modal of claim 1, wherein the first electric motor and the second electric motor turn the first tire and the second tire in torque mode to simulate a positive traction integrated steering rack.

3. The insertable drive modal of claim 1, wherein the modal has a rack and pinion steering system.

4. The insertable drive modal of claim 1, wherein independent suspension is provided for each wheel.

5. The insertable drive modal of claim 1, wherein the first and at least one second electric motor engage with the same frame, brakes, and steering configuration of an existing vehicle.

6. The insertable drive modal of claim 1, wherein equal torque is provided to each tire.

7. The insertable drive modal of claim 1, wherein a smart communications link is established between the first electric motor and the at least one second electric motor.

8. The insertable drive modal of claim 1, wherein a second drive modal is used in association with the first drive modal to control at least a third tire and at least a fourth tire.

9. The insertable drive modal of claim 8, wherein the second drive modal lacks motors, sprockets and half shafts.

10. The insertable drive modal of claim 8, wherein the first drive modal has a rack and pinion steering mechanism and the second drive modal has a tie link toe adjustment.

11. A method for converting an internal combustion vehicle to an electric vehicle comprising:
inserting a drive modal into an existing chassis of an existing vehicle;
wherein the drive modal comprises;
a first electric motor engaged with a first tire;
at least one second electric motor engaged with at a second tire;
wherein the first electric motor effects movement of the first tire without a gear differential and the second electric motor effects movement of the second tire without a gear differential;
wherein the first electric motor effects movement of the first tire without a transmission disposed between the first electric motor and the first tire and the at least one second electric motor effects movement of the second tire without a transmission disposed between the at least one second electric motor and the second tire.

12. The method of claim 11, wherein the drive modal is inserted into the existing chassis at a front of the vehicle to provide four by two front wheel drive.

13. The method of claim 11, wherein the drive modal is inserted into the existing chassis at a rear of a vehicle to provide four by two rear wheel drive.

14. The method of claim 11, wherein a second drive modal is inserted into the vehicle to provide four by four wheel drive.

15. The method of claim 11, wherein the first and at least one second electric motor engage with the same frame, brakes, and steering configuration of an existing vehicle.

16. The method of claim 11, wherein independent suspension is provided for each wheel.

17. The method of claim 11, wherein the first and at least one second electric motor engage with the same frame, brakes, and steering configuration of an existing vehicle.

18. The method of claim 11, wherein equal torque is provided to each tire.

19. The method of 14, wherein the second drive modal is a non-steering unit and a rack of the existing vehicle may be replaced with toe links.
